(19) United States
(12) Patent Application Publication
(10) Pub. No.: US 2005/0172554 A1
(43) Pub. Date: Aug. 11, 2005

(54) Fuel reformer housing container and fuel reforming apparatus

(75) Inventors: Yoshihiro Basho, Kokubu-shi (JP); Masaaki Miyahara, Kokubu-shi (JP); Ryuji Mori, Kokubu-shi (JP); Toshihiro Hashimoto, Kokubu-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/057,122

(22) Filed: Feb. 10, 2005

(30) Foreign Application Priority Data
Feb. 10, 2004 (JP) P2004-033453
Mar. 18, 2004 (JP) P2004-078494
Mar. 23, 2004 (JP) P2004-084279
Apr. 27, 2004 (JP) P2004-130936

(51) Int. Cl. C10J 1/00

(52) U.S. Cl. 48/127.9; 48/61

(57) ABSTRACT

A fuel reformer housing container includes a base having an upper surface including a concave portion for housing a fuel reformer for generating reformed gas including hydrogen gas from fuel therein; a lid attached to the upper surface of the base so as to cover the concave portion; a supply pipe for supplying fuel to the fuel reformer, the supply pipe piercing the base so that a front end thereof is joined to the fuel reformer, and holding the fuel reformer in a space between the lid and a bottom surface of the concave portion; and a discharge pipe for discharging the reformed gas, the discharge pipe piercing the base so that a front end thereof is joined to the fuel reformer, and holding the fuel reformer in a space between the lid and the bottom surface of the concave portion. The base and the lid have cavities formed therein.

### BACKGROUND OF THE INVENTION

1. Field of the Invention

The present invention relates to a fuel reformer housing container for constituting a fuel reforming apparatus using a fuel reformer that generates hydrogen gas from all sorts of fuels by utilizing a steam reforming reaction which is an endothermic catalytic reaction, in, for example, a fuel cell system, and also relates to the fuel reforming apparatus.

2. Description of the Related Art

In recent years, a fuel cell system has been in the limelight as a next-generation power source system that produces electric energy efficiently and cleanly, and in an automobile market and a market of a cogeneration power generation system typified by a household fuel cell power generation system, field tests for practical implementation aiming at cost reduction have been executed energetically already.

Besides, it has been examined recently to miniaturize the fuel cell system and use as a power source of mobile equipment such as a mobile phone, a PDA (Personal Digital Assistant), a notebook computer, a digital video camera and a digital still camera.

Generally, in a fuel cell, hydrocarbon gas such as methane and natural gas (CNG) or alcohol such as methanol and ethanol is used as fuel, and power generation is performed by reforming to hydrogen gas and another gas by a steam reforming reaction in a fuel reforming apparatus using a fuel reformer and thereafter supplying the hydrogen gas to a power generation apparatus referred to as a power generation cell.

In this case, reforming of fuel by the fuel reformer is a process of bonding a reformable fuel to steam and generating hydrogen gas by a catalytic reaction.

For example, in the case of using methanol as fuel, it is a process of generating hydrogen gas (H₂) by a steam reforming reaction as expressed by the following chemical equation (1) (a reaction of bonding steam to methanol and thereby, reforming methanol to hydrogen and carbon dioxide in the equation (1)). A minute amount of generated gas (mainly CO₂) other than hydrogen generated by the reforming reaction is discharged into the air usually.
CH₃+OH+H₂O→3H₂+CO₂ (1)

Further, since the steam reforming reaction is an endothermic reaction, it is necessary to heat fuel with a heater or the like from outside and maintain a reaction temperature. Therefore, for reforming fuel in the fuel reformer, in order to prevent steam reforming activity of a catalyst from lowering and keep the density of produced hydrogen gas high, temperatures of approximately 200 to 500° C. are required in the case of using methanol as fuel, and temperatures as high as approximately 300 to 800° C. are required in the case of using methane gas, for example. As a related art, there is Japanese Unexamined Patent Publication JP-A 2003-2602.

In recent years, it has been proposed to mount the fuel cell system on a small mobile equipment. In order to realize the proposition, a fuel cell apparatus is requested to be small in size and low in height.

Furthermore, in a case where the fuel cell system is mounted on a small mobile equipment, the heat generated in the fuel reformer is conducted to the fuel reformer housing container, and the temperature of the surface of the fuel reformer housing container rises, so that there is a danger that the heat breaks other components in the mobile equipment.

Further, since the steam reforming reaction as expressed by the chemical equation (1) is an endothermic reaction, it is necessary for reforming fuel in the fuel reformer to heat the fuel reformer with a heater or the like and thereby, keep a reaction temperature at a fixed temperature. However, the heat generated in the fuel reformer is conducted to the fuel reformer housing container and thereby, the temperature of the fuel reformer lowers. Then, in order to maintain the reaction temperature, it is necessary to increase the amount of power generation of the heater. In a case where the amount of power generation of the heater is increased, there arises a problem that electric capacity used for heating the heater occupying in the total electric capacity generated in the power generation cell of the fuel cell increases, and that power generation loss in the whole fuel cell system increases as a result.

As a method for restraining the heat generated in the fuel reformer from being conducted to the fuel reformer housing container, there is considered to be a method in which a main body of the fuel reformer housing container is composed of a glass material with low-thermal conduction, but glass materials generally have low intensity and therefore, the glass material cracks when a supply pipe for supplying fuel or a discharge pipe for discharging the reformed gas is joined thereto. Consequently, there arises a problem that it is difficult to secure airtightness at junctions to the supply pipe and the discharge pipe.

### SUMMARY OF THE INVENTION

The invention has been completed in consideration of the problems in the related art, and an object thereof is to provide a fuel reformer housing container and fuel reforming apparatus that are capable of favorably supplying fuel to a fuel reformer and safely discharging reformed gas such as hydrogen gas obtained by reforming in the fuel reformer to the outside of the fuel reformer housing container and in which efficiency of power generation is high by restraining the heat generated in the fuel reformer from being conducted to the fuel reformer housing container and which can be mounted on a small mobile apparatus.

The invention provides a fuel reformer housing container comprising:
a base having one surface including a concave portion for housing a fuel reformer for generating reformed gas including hydrogen gas from fuel therein;
a lid attached to the one surface of the base so as to cover the concave portion;
a supply pipe for supplying fuel to the fuel reformer, the supply pipe piercing at least one of the base and the lid so that a front end thereof is joined to the fuel reformer, and holding the fuel reformer in a space between the lid and a bottom surface of the concave portion; and
a discharge pipe for discharging the reformed gas, the discharge pipe piercing at least one of the base and the lid so that a front end thereof is joined to the fuel reformer, and holding the fuel reformer in a space between the lid and the bottom surface of the concave portion,
wherein at least one of the base and the lid has a cavity formed therein.

In the invention, it is preferable that the cavity has a dimension of 0.5 mm to 5 mm in a direction perpendicular to walls on interior side and exterior side of the at least one of the base and lid which define the cavity.

In the invention, it is preferable that the interior side wall and exterior side wall of the at least one of the base and the lid which define the cavity have thicknesses of 0.1 mm or more, respectively.

In the invention, it is preferable that the lid consists of a plurality of lid portions which are attached to the one surface of the base so as to be layered and have a gap therebetween, and lid portions which are on more interior side are attached to more inner periphery of the one surface of the base.

In the invention, it is preferable that the one surface of the base except the concave portion is shaped into a step, and the plurality of lid portions are respectively attached to different surfaces of the step.

In the invention, it is preferable that a distance of the gap is from 0.5 mm to 5 mm.

In the invention, it is preferable that thicknesses of the lid portions are 0.1 mm or more.

In the invention, it is preferable that the cavity formed in at least one of the base and the lid has a pressure reduced to lower than the atmosphere pressure, and the at least one of the base and the lid has a gas suction port for reducing pressure of the cavity provided in a portion on the fuel reformer side of the at least one of the base and the lid.

In the invention, it is preferable that the cavity has a dimension of 0.5 mm to 5 mm in a direction perpendicular to walls on interior side and exterior side of the at least one of the base and lid which define the cavity.

In the invention, it is preferable that the interior side wall and exterior side wall of the at least one of the base and lid which define the cavity have thicknesses of 0.1 mm or more, respectively.

In the invention, it is preferable that the cavity of the at least one of the base and the lid has a pressure reduced to lower than the atmosphere pressure, and a first gas suction pipe for reducing pressure of the cavity is formed in the exterior side wall of the at least one of the base and the lid and a second gas suction pipe for reducing pressure in the fuel reformed housing container is formed in the interior side wall of the at least one of the base and the lid so as to extrude from the interior side wall through an inside to an opening of the first gas suction pipe.

In the invention, it is preferable that the second gas suction pipe protrudes outwardly from the opening of the first gas suction pipe.

In the invention, it is preferable that the cavity has an inner pressure of 10 Pa or less.

The invention provides a fuel reforming apparatus comprising the fuel reformer housing container of the above-mentioned invention and a fuel reformer installed in the concave portion for generating reformed gas including hydrogen gas from fuel.

In the invention, it is preferable that the concave portion has an inner pressure of 10 Pa or less.

According to the invention, a fuel reformer housing container comprises a base having one surface including a concave portion for housing a fuel reformer for generating reformed gas including hydrogen gas from fuel therein; a lid attached to the one surface of the base so as to cover the concave portion; a supply pipe for supplying fuel to the fuel reformer, the supply pipe piercing at least one of the base and the lid so that a front end thereof is joined to the fuel reformer, and holding the fuel reformer in a space between the lid and a bottom surface of the concave portion; and a discharge pipe for discharging the reformed gas, the discharge pipe piercing at least one of the base and the lid so that a front end thereof is joined to the fuel reformer, and holding the fuel reformer in a space between the lid and the bottom surface of the concave portion. At least one of the base or the lid has a cavity formed therein. Therefore, it is not necessary to directly join the whole rear surface of the fuel reformer to the inside of the base and lid by surface junction and it is possible to effectively restrain the heat of the fuel reformer from being conducted to the base and lid. As a result, it is possible to thermally insulate the fuel reformer and restrain the temperature of the fuel reformer from decreasing, it is not necessary to keep supplying a large amount of electric power to a heater for maintaining a temperature necessary for favorably operating the fuel reformer, and it is possible to outstandingly increase the efficiency of power generation.

Further, it is possible to effectively insulate the heat by the cavity formed in the base and/or the lid and largely reduce thermal conduction from the fuel reformer to the exterior side surface of the base and/or lid. Therefore, it becomes possible to effectively restrain the temperature of an exterior side surface of the fuel reformer housing container from rising. As a result, it is possible to effectively prevent other components in a mobile apparatus from being broken.

According to the invention, the cavity has a dimension of 0.5 mm to 5 mm in a direction perpendicular to the interior side and exterior side walls of the base and/or lid which define the cavity. Therefore, the fuel reformer housing container that is small in size and hardly conducts the heat outward, can be realized, and further it is possible to favorably absorb a mechanical shock by the cavity and reduce a shock directly conducting inward the fuel reformer housing container to a large extent. As a result, it is possible to improve operating reliability of the fuel reformer housed inside of the fuel reformer housing container.

According to the invention, since the interior side wall and exterior side wall of the at least one of the base and the lid which define the cavity have thicknesses of 0.1 mm or more, respectively, it is possible to more effectively reduce the heat diffused from the fuel reformer to the exterior of the base and lid. As a result, it is possible to more effectively restrain the temperature of the fuel reformer from decreasing and restrain the temperature of the fuel reformer housing container from rising, and power generation loss can be reduced more.

According to the invention, since the lid consists of a plurality of lid portions which are attached to the one surface of the base so as to be layered and have a gap therebetween, it is possible to effectively insulate the heat by the gap disposed between the lid portions, i.e. the cavity and largely reduce thermal conduction from the fuel reformer to the most exterior side walls of the lid. Thereby, it becomes possible to effectively restrain the temperature of an exterior side surface of the fuel reformer housing container from rising. As a result, it is possible to effectively prevent other components in a mobile apparatus from being broken.

Furthermore, lid portions which are on more interior side are attached to more inner periphery of the one surface of the base. Therefore, even when a sealing trouble occurs at a junction between one lid portion and the base, a junction between other lid portions and the base are maintained favorably. Consequently, airtightness inside the fuel reformer housing container can be maintained, and it is possible to effectively restrain the heat in the fuel reformer from being conducted to the most exterior side surface of the lid.

According to the invention, the one surface of the base except the concave portion is shaped into a step, and the plurality of lid portions are respectively attached to different surfaces of the step. Therefore, in a case where the lid portions are joined to the one surface of the base via a brazing material, adjacent lid portions are connected by prevailing of the brazing material in a wet condition between the lid portions, and an adhesion area of the brazing material and the one surface of the base becomes larger so that stress is effectively restrained from arising on the adhesion surface. Further, in a case where the lid portion is welded to the one surface of the base, after welding one lid portion, it is possible to make it difficult to conduct the heat to the junction of the lid portion which is already welded, and the base when other lid portion is welded so that stress is effectively restrained from arising on the junction.

Thus, even when a space for joining on the one surface of the base become small by downsizing the fuel reformer housing container, the plurality of lid portions are joined to the base with considerably high reliability.

Especially when a higher surface of the step is disposed closer to the concave portion than to the outside of the base, it becomes easy to seam-weld the interior side lid portion when the lid portion is attached to the one surface of the base by seam-welding. In other words, an electrode roller for seam-welding is disposed at an angle in order to increase a value of resistance on welding, however, the higher surface of the step is disposed closer to the concave portion than to the outside of the base and thereby, it can be effectively prevented that welding cannot be attained with the electrode roller in contact with the one surface of the base when the interior side lid portion is welded.

According to the invention, since a distance of a gap between a plurality of lid portions is from 0.5 mm to 5 mm, the fuel reformer housing container can be small in size and hardly conducts the heat outward, and it is possible to favorably absorb mechanical shock by the gap and reduce a shock directly conducting inward the fuel reformer housing container to a large extent. As a result, it is possible to improve operating reliability of the fuel reformer housed inside of the fuel reformer housing container.

According to the invention, since lid portions have thicknesses of 0.1 mm or more, it is possible to more effectively reduce the heat diffused from the fuel reformer to the outsides of the lid portions. As a result, it is possible to more effectively restrain the temperature of the fuel reformer from decreasing and restrain the temperature of the fuel reformer housing container from rising, and power generation loss can be reduced more.

According to the invention, since at least one of the base and the lid has a cavity having the reduced pressure than the atmosphere pressure, it is possible to effectively insulate the heat by the cavity formed in the base/the lid and largely reduce thermal conduction from the fuel reformer to exterior side walls of the base and lid. Therefore, it becomes possible to effectively restrain the temperature of an exterior side wall of the fuel reformer housing container from rising. As a result, it is possible to effectively prevent other components in a mobile apparatus from being broken.

Furthermore, since all the gas suction ports for decreasing pressure inside the cavity formed on the base and/or the lid are formed inside the fuel reformer housing container, the gas suction ports do not protrude on an exterior side surface of the fuel reformer housing container, and it is possible to lower the fuel reformer housing container in height. As a result, it is possible to provide a fuel reformer housing container and a fuel reformer apparatus which can be mounted on a small mobile apparatus.

Further, since there is no gas suction port on an exterior side surface of the fuel reformer housing container, the heat is diffused outward from the gas suction port, and it is possible to effectively restrain the temperature of the fuel reformer from decreasing.

Furthermore, when inner pressure inside the fuel reformer housing container is decreased to the same pressure as that inside the cavity, even when a gas suction port is broken and open, since the fuel reformer housing container and the cavity have the same inner pressure, airtightness of the fuel reformer housing container and cavity can be maintained, and it is possible to favorably maintain the restraint of thermal conduction from the fuel reformer to an exterior side surface of the fuel reformer housing container.

According to the invention, at least one of the base and the lid has a cavity, a first gas suction pipe and a second gas suction pipe formed therein, the cavity having the reduced pressure than the atmosphere pressure, the first gas suction pipe being on an exterior side wall for decreasing pressure inside the cavity, and the second gas suction pipe being for decreasing pressure inside the fuel reformer housing container which extrudes from the interior side wall through the inside to the opening of the first gas suction pipe. Therefore, it is possible to effectively insulate the heat by the cavity formed on the base and/or the lid and largely reduce thermal conduction from the fuel reformer to exterior side walls of the base and lid. Therefore, it becomes possible to effectively restrain the temperature of an exterior side wall of the fuel reformer housing container from rising. As a result, it is possible to effectively prevent other components in a mobile apparatus from being broken.

Further, inside a first gas suction pipe for decreasing pressure inside the cavity formed on the base and/or the lid, is formed a second gas suction pipe for decreasing pressure inside a space between the lid and a bottom surface of the concave portion which secures the fuel reformer apparatus. Therefore, after decreasing pressure inside the cavity of the base, cavity of the lid and fuel reformer housing container, the first and second gas suction pipes are welded by pressure and thereby, it is possible to seal a plurality of suction pipes at one time and considerably simplify manufacturing process.

According to the invention, since the second gas suction pipe protrudes outward than the opening of the first gas suction pipe, it is possible to separately vacuum up the fist and second gas suction pipes respectively and vacuum up as maintaining a state where inner pressure of the cavity of the base/the cavity of the lid is different from that of the fuel reformer housing container. In other words, as vacuuming up under a state where the inner pressure of the cavity of the base/the cavity of the lid is smaller than that of the fuel reformer housing container, after the inner pressure of the cavity of the base and cavity of the lid is firstly brought to a desired value, the inner pressure of the fuel reformer housing container is brought to a desired value and thereby, a difference of air pressure becomes very wide at the vacuuming, and it is possible to effectively restrain the base and lid from sagging, and the airtightness of the fuel reformer housing container can become favorable.

According to the invention, since the cavity has the inner pressure of 10 Pa or less, it is possible to lower molecular density in the air inside the cavity, and effectively reduce the amount of heat conduction between the interior side surface and exterior side surface of the base via the cavity. As a result, it is possible to more effectively reduce the heat conducted from the fuel reformer to the base and lid, and power generation loss can be reduced more by restraining the temperature of the fuel reformer from decreasing, and the temperature of the fuel reformer housing container can be more effectively restrained from rising.

According to the invention, the fuel reforming apparatus comprises the fuel reformer housing container of the above-mentioned invention and the fuel reformer installed in the concave portion for generating reformed gas including hydrogen gas from fuel. Therefore, it becomes a fuel reforming apparatus that is provided with features of the fuel reformer housing container of the above-mentioned invention and capable of safely discharging gas such as hydrogen gas obtained by reforming in the fuel reformer to the outside of the fuel reformer housing container and making power generation loss small.

According to the invention, since the cavity has the inner pressure of 10 Pa or less, it is possible to increase the insulation effectiveness inside of the fuel reformer housing container, and effectively reduce the heat conducted from the fuel reformer to the base and lid. Therefore, it is not necessary to keep supplying a large amount of electric power to a heater for maintaining a temperature necessary for favorably operating the fuel reformer, and it is possible to outstandingly increase the efficiency of power generation.

### BRIEF DESCRIPTION OF THE DRAWINGS

Other and further objects, features, and advantages of the invention will be more explicit from the following detailed description taken with reference to the drawing wherein:

FIG. 1 is a cross sectional view showing a fuel reformer housing container and fuel reforming apparatus according to a first embodiment of the invention;

FIG. 2 is a cross sectional view showing a fuel reformer housing container and fuel reforming apparatus according to a second embodiment of the invention;

FIG. 3 is a cross sectional view showing a fuel reformer housing container and fuel reforming apparatus according to a third embodiment of the invention;

FIG. 4 is a cross sectional view showing a fuel reformer housing container and fuel reforming apparatus according to a fourth embodiment of the invention;

FIG. 5 is a cross sectional view showing a fuel reformer housing container and fuel reforming apparatus according to a fifth embodiment of the invention.

### DETAILED DESCRIPTION OF PREFERABLE EMBODIMENTS

Now referring to the drawings, preferred embodiments of the invention are described below.

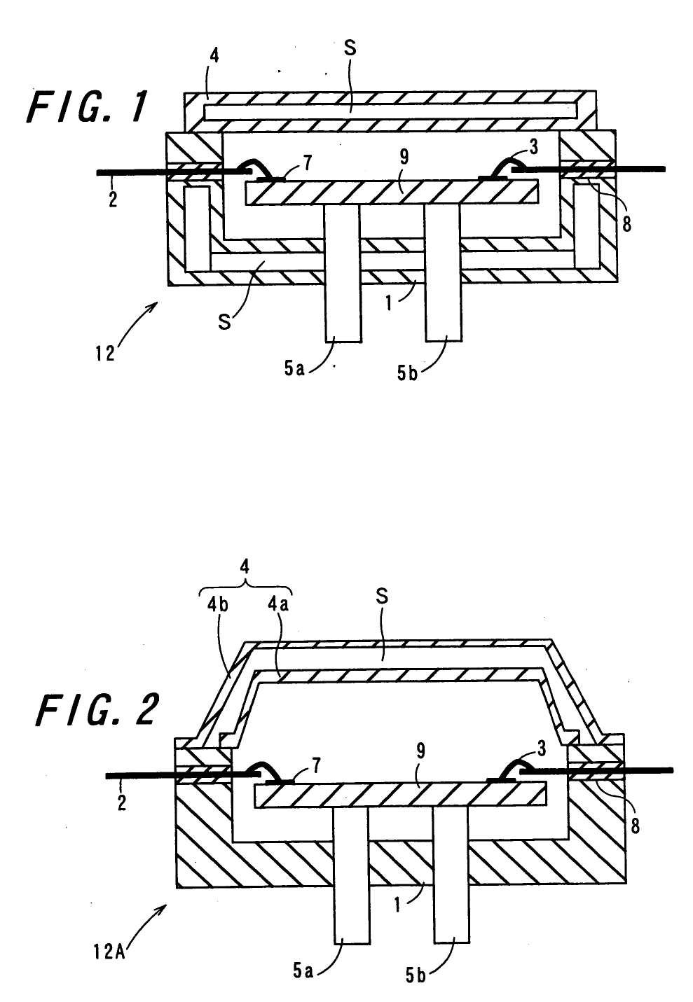

FIG. 1 is a cross sectional view showing a fuel reformer housing container and fuel reforming apparatus according to a first embodiment of the invention. A fuel reforming apparatus includes a base 1, a lead terminal 2 serving as a wire, a bonding wire 3, a lid 4, a supply pipe 5a serving as a supplying passage for supplying fuel, a discharge pipe 5b serving as a discharging passage for discharging reformed gas, an electrode 7, an insulation sealing member 8 for sealing and fixing the lead terminal 2 in a through hole of the base 1 in an insulated state, and a fuel reformer 9. A fuel reformer housing container 12 for housing the fuel reformer 9 is mainly composed of the base 1, the lid 4, the supply pipe 5a and the discharge pipe 5b. Therefore, the fuel reforming apparatus comprises the fuel reformer housing container 12 and the fuel reformer 9.

The fuel reformer 9 generates reformed gas including hydrogen gas from fuel. The base 1 has an upper surface as one surface including a concave portion for housing the fuel reformer 9 therein. The lid 4 is attached to the upper surface of the base 1 to cover the concave portion. The supply pipe 5a is for supplying the fuel to the fuel reformer 9. The supply pipe 5a pierces at least one of the base 1 and the lid 4 (in the embodiment, the base 1) so that a front end thereof is joined to the fuel reformer 9. Further, the supply pipe 5a holds the fuel reformer 9 in a space between the lid 4 and a bottom surface of the concave portion. The discharge pipe 5b is for discharging the reformed gas. The discharge pipe 5b pierces at least one of the base 1 and the lid 4 (in the embodiment, the base 1) so that a front end thereof is joined to the fuel reformer 9. Further, the discharge pipe 5b holds the fuel reformer 9 in a space between the lid 4 and the bottom surface of the concave portion. That is, the supply pipe 5a and the discharge pipe 5b are provided so that the front ends thereof protrude from the bottom surface of the concave portion of the base 1, and arrange the fuel reformer 9 in the space between the lid 4 and the bottom surface of the concave portion of the base 1, in a state where the fuel reformer 9 is away from the bottom surface of the concave portion of the base 1 and a surface of the lid 4 facing the concave portion.

Both the base 1 and the lid 4 in the invention have a role as a container that houses the fuel reformer 9. They are made of, for example, a metallic material such as an Fe alloy, oxygen free copper and stainless steel, a ceramic material such as aluminum oxide (Al₂O₃) sintered body, mullite (3Al₂O₃.2SiO₂) sintered body, silicon carbide (SiC) sintered body, aluminum nitride (AlN) sintered body, or silicon nitride (Si₃N₄) sintered body and glass ceramics.

In a case where the base 1 and the lid 4 is composed of glass ceramics, as glass ceramics applicable to the base 1 and lid 4, for example, one comprising a glass component and a filler component is used. The glass component is, for example, SiO₂—B₂O₃, SiO₂—B₂O₃—Al₂O₃, SiO₂—B₂O₃—Al₂O₃-MO (M represents Ca, Sr, Mg, Ba or Zn), SiO₂—Al₂O₃-M¹O-M²O (M¹ and M² are the same or different, and represent Ca, Sr, Mg, Ba or Zn), SiO₂—B₂O₃—Al₂O₃-M¹O-M²O (M¹ and M² are as described above), SiO₂—B₂O₃-M³₂O (M³ represents Li, Na or K), SiO₂—B₂O₃—Al₂O₃-M³₂O (M³ is as described above), Pb glass, and Bi glass.

Further, the filler component is, for example, a composite oxide of Al₂O₃, SiO₂, ZrO₂ and an alkaline earth metal oxide, a composite oxide of TiO₂ and an alkaline earth metal oxide, and a composite oxide (for example, spinel, mullite, and cordierite) containing at least one selected from the group consisting of Al₂O₃ and SiO₂.

At least one of the base 1 and lid 4 of the invention (in the embodiment, base 1 and lid 4) has a cavity S formed therein. Thereby, it is possible to effectively insulate the heat, and since it is possible to largely reduce thermal conduction from the fuel reformer 9 to exterior side surfaces of the base 1 and lid 4, it becomes possible to effectively restrain the temperature of an exterior side surface of the fuel reformer housing container 12 from rising. As a result, it is possible to effectively prevent other components in a mobile apparatus from being broken.

In a case where the base 1 and the lid 4 are made of a compact aluminum oxide sintered body whose relative density is 95% or more, the base 1 and the lid 4 are fabricated as follows. For example, a sintering aid such as rare-earth oxide powder and aluminum oxide powder is added and mixed into aluminum oxide powder at first, whereby powder of a raw material of aluminum oxide sintered body is prepared. Next, an organic binder and a dispersion medium are added and mixed into the powder of the raw material so as to become paste and the paste is processed by a doctor blade method, or the organic binder is added into the powder of the raw material and a mixture thereof is processed by press molding, rolling molding or the like, whereby a green sheet having a predetermined thickness is produced. Then, a through hole is provided on a specific green sheet to be a cavity S and, a predetermined number of sheet-shaped products are aligned, laminated and bonded by pressure, and thereafter, the laminated product is baked, for example, at baking maximum temperatures of 1200 to 1500° C. in a non-oxidative atmosphere. In this way, the base 1 and the lid 4 made of ceramic are obtained as aimed. The base 1 and the lid 4 may be formed by a powder mold pressing method. Further, a ceramic fired substance with a concave portion is formed, thereafter the base 1 and the lid 4 with the cavity S may be formed by joining with another ceramic fired substance so as to cover the concave portion.

Furthermore, in a case where the base 1 and the lid 4 are made of a metallic material, ends of two compacts formed into predetermined shapes by a cutting method, a pressing method, an MIM (Metal Injection Mold) method or the like, are joined by a brazing material and a welding method, thereby, the base 1 and lid 4 with the cavity S therein are obtained.

Further, in order to prevent corrosion, it is desired that the surfaces of the base 1 and lid 4 are subjected to, for example, plating treatment with Au or Ni, or coating treatment such as resin coating with polyimide or the like. For example, in the case of Au plating treatment, it is desired that the thickness is approximately 0.1 to 5 μm. urther, by covering at least an interior side surface of the fuel reformer housing container 12 composed of the base 1 and the lid 4 with a plating treatment film of Au or Al, it is possible to efficiently prevent the radiant heat emitted by the housed fuel reformer 9, and it becomes possible to restrain increase of the temperature of the fuel reformer housing container 12.

In the base 1 and lid 4, it is preferable that the cavity S has the inner pressure of 10 Pa or less. Thereby, it is possible to lower molecular density in the air inside the cavity S, and effectively reduce the amount of heat conduction between the interior side surface and exterior side surface of the base 1 via the cavity S. As a result, it is possible to more effectively reduce heat conducted from the fuel reformer 9 to the base 1 and lid 4, and power generation loss can be reduced more by restraining the temperature of the fuel reformer 9 from decreasing, and the temperature of the fuel reformer housing container 12 can be effectively restrained from rising.

Correspondingly, it is preferable that an inner pressure is 10 Pa or less in the fuel reformer housing container 12, that is, in a space between the lid 4 and the bottom surface of the concave portion of the base 1.

Thus, as a method for lowering the inner pressure of the cavity S, for example, in a case where the cavity S is formed by joining two materials, when the two materials are joined each other, it is possible to implement by sealing by a brazing material inside a vacuum furnace, a seam weld method inside a vacuum chamber and the like. Alternatively, it may also be implemented by providing a through hole in the base 1 and lid 4 with the cavity S to connect the cavity S and outside, lowering pressure inside the cavity S by vacuuming up from the through hole, and thereafter covering the through hole.

Further, as a method for lowering the inner pressure between the lid 4 and the base 1, for example, when the lid 4 is joined to the base 1, it is possible to implement by sealing by a brazing material inside a vacuum furnace, a seam weld method inside a vacuum chamber and the like. Alternatively, it may also be implemented by providing a through hole in the lid 4, lowering pressure inside the concave portion of the base 1 by vacuuming up from the through hole, and thereafter covering the through hole.

Further, it is preferable that the cavity S has a dimension of 0.5 mm to 5 mm in a direction perpendicular to interior side and exterior-side surfaces of the base 1 and lid 4. Thereby, a fuel reformer housing container 12 can be small in size and hardly conducts the heat outward, and it is possible to favorably absorb a mechanical shock by the cavity S and reduce a shock directly conducting inward the fuel reformer housing container 12 to a large extent. As a result, it is possible to improve operating reliability of the fuel reformer 9 housed inside of the fuel reformer housing container 12. Further, in a case where insulation effectiveness is increased by lowering the pressure of the cavity S close to a vacuum, it is possible to restrain contact of the interior side and exterior side surfaces of the base 1 and lid 4 even with the base 1 and lid 4 deformed to some extent, and retain a stable structure. Therefore, it can be favorably maintained to restrain the thermal conduction from the fuel reformer 9 to the exterior side surface of the base 1 and lid 4.

Further, it is preferable that the interior side walls and the exterior side walls of the base 1 and lid 4 have thicknesses of 0.1 mm or more, respectively. Thereby, it is possible to more effectively reduce the heat diffused from the fuel reformer 9 to the exterior of the base 1 and lid 4. As a result, it is possible to more effectively restrain the temperature of the fuel reformer 9 from decreasing and restrain the temperature of the fuel reformer housing container 12 from rising and thereby, power generation loss can be reduced more. Further, since it is possible to increase the mechanical strength of the base 1 and lid 4, the cavity S in a stable volume can be retained. As a result, it can be favorably maintained to restrain the thermal conduction from the fuel reformer 9 to the most exterior side surfaces of the base 1 and lid 4, and it is possible to maintain efficiency of power generation as stable and high over a long period of time.

The cavity S of the base 1 may be formed on a part of the base 1, and it may also be formed so as to cover the entire surrounding of the concave portions. For example, it may be formed at the bottom or on the side so as to be parallel to the interior side and exterior side walls of the base 1, or it may be formed at the bottom or on the side of the base 1 in a row, parallel to the interior side and exterior side walls as though it has a dual structure.

Next, it is preferred that the lead terminal 2 of the invention is made of metal whose thermal expansion coefficient is equal or approximate to those of the base 1 and lid 4. When the lead terminal 2 is made of, for example, an Fe—Ni alloy or an Fe—Ni—Co alloy, it is capable of preventing occurrence of thermal strain to a temperature change in practical implementation. Besides, it is capable of exhibiting a favorable sealing adhesion property between the lead terminal 2 and the base 1, and excellent in bonding property, so that necessary strength for mounting and a favorable soldering property and welding property can be secured.

Further, the insulation sealing member 8 of the invention is made of, for example, borosilicate glass, alkali glass and insulation glass whose principal ingredient is lead, and the base 1 and the lead terminal 2 are electrically insulated by the insulation sealing member 8 in a through hole formed in the base 1, and the lead terminal 2 is sealed and fixed. The through hole that is formed in the base 1 and where the lead terminal 2 is inserted needs to have a size such that the base 1 and the lead terminal 2 do not come in contact to be electrically conducted, in specific, needs to have an inner diameter such that an interval between the lead terminal 2 and the base 1 of 0.1 mm or more can be secured.

The insulation sealing member 8 may be made of, for example, an insulation member such as ceramics like aluminum oxide sintered body and glass. In this case, for example, by inserting the insulation sealing member 8 having a tubular shape into the through hole formed in the base 1, and further inserting the lead terminal 2 into the insulation sealing member 8, it is possible to electrically insulate the base 1 and the lead terminal 2. When joining the insulation sealing member 8 to the base 1 and joining the insulation sealing member 8 to the lead terminal 2, it is possible to use a brazing material such as an Au—Ge alloy and an Ag—Cu alloy.

Then, the electrode 7 on the fuel reformer 9 and the lead terminal 2 are electrically connected via the bonding wire 3. Furthermore, a concave portion of the base 1 is sealed by the use of the lid 4, whereby a fuel reforming apparatus that the fuel reformer 9 housed in the concave portion of the fuel reformer housing container 12 is hermetically sealed is formed.

Further, the fuel reformer 9 housed in the fuel reformer housing container 12 of the invention is formed as follows. By applying a semiconductor production technique, a liquid fluid channel is produced, for example, by forming a thin groove on a substrate made of an inorganic material such as semiconductor like silicon, silica, glass and ceramics by means of a cutting method, an etching method, a blast method or the like. A cover such as a glass plate is closely attached to a principal surface of the substrate in which the liquid fluid channel is produced by anodic bonding brazing or the like for the purpose of prevention of evaporation of a fluid in operation. In such a state, the fuel reformer 9 is used as a minute chemical device.

Inside the fuel reformer 9, a temperature adjusting mechanism such as a thin film heater (not shown) formed by a resistance layer or the like is formed, and on the surface, the electrode 7 is formed as a terminal that supplies electric power to the thin film heater. With the temperature adjusting mechanism, the temperature of the fuel reformer 9 is adjusted to approximately 200 to 800° C. as a temperature condition that corresponds to a fuel reforming condition. Consequently, it is possible to favorably accelerate a reforming reaction of bonding fuel supplied from a fuel supply opening to which the supply pipe 5a is connected, to steam and generating hydrogen gas from the discharge pipe 5b connected to a reformed gas discharge opening.

The fuel reformer 9 is housed inside the concave portion of the base 1 and housed in the fuel reformer housing container 12 so that the lid 4 is attached to the upper surface of the base 1 to cover the concave portion by junction with a metallic brazing material such as an Au alloy, an Ag alloy and an Al alloy or a glass material, a seam weld method or the like.

For example, joining the lid 4 to the base 1 with an Au—Sn brazing material is made as follows. That is, the Au—Sn brazing material is welded to the lid 4 in advance, or the Au—Sn brazing material formed into a frame-shape by punching processing or the like by the use of a die or the like is placed between the base 1 and the lid 4, and thereafter, the lid 4 is joined to the base 1 in a sealing furnace or a seam welder. Consequently, it is possible to seal the fuel reformer 9 in the fuel reformer housing container 12.

Further, the fuel reformer 9 is formed so that the electrode 7 on the fuel reformer 9 is electrically connected to the lead terminal 2 disposed to the base 1 via the bonding wire 3. Consequently, it is possible to heat the heater formed on the fuel reformer 9 through the electrode 7. As a result, it becomes possible to maintain a reaction temperature in the fuel reformer 9, and it is possible to stabilize a reforming reaction of fuel.

The supply pipe 5a and the discharge pipe 5b are a supplying passage of a raw material and a fuel gas fluid and a discharging passage of reformed gas containing hydrogen, respectively. They are made of, for example, a metallic material such as an Fe—Ni alloy, an Fe—Ni—Co alloy and stainless steel, a ceramic material such as Al₂O₃ sintered body, 3Al₂O₃.2SiO₂ sintered body, SiC sintered body, AlN sintered body, Si₃N₄ sintered body and glass ceramic sintered body, a resin material having high heat resistance such as polyimide, or glass.

It is preferred that they are made of a material hard to be embrittled by hydrogen contained in reformed gas. Such a material is an Fe alloy, ceramics, and glass.

The supply pipe 5a and the discharge pipe 5b are joined to the fuel reformer 9 by an anodic bonding method, a welding method, brazing method or the like.

Further, it is preferred that the opening area of the discharge pipe 5b is larger than the opening area of a discharge hole of the fuel reformer 9. Consequently, it is possible to make the resistance of a flow of reformed gas from the fuel reformer 9 to the discharge pipe 5b to be small, and it is possible to smooth discharge of reformed gas from the fuel reformer 9 and largely increase fuel reforming efficiency.

For joining the supply pipe 5a and discharge pipe 5b and the base 1 or lid 4, various sorts of methods including ultrasonic junction, heat welding, pressure bonding, adhesion with a resin adhesive, junction with a brazing material such as Au—Si and Ag—Cu, junction with glass such as borosilicate glass, and simultaneous sintering are properly used according to materials forming the supply pipe 5a, the discharge pipe 5b, the base 1 and the lid 4.

The supply pipe 5a and the discharge pipe 5b are inserted to the through hole formed on the base 1 or the lid 4, and can be joined thereto. Alternatively, the through hole may also be formed on the base 1 or the lid 4, and the two supply pipes 5a may also be joined respectively to opening edges of interior side and exterior side wall of the base 1 or lid 4 so that the through hole and the two supply pipes 5a are communicated with each other. Correspondingly, the through hole may also be formed on the base 1 or the lid 4, and the two discharge pipes 5b may also be joined respectively to opening edges of interior side and exterior side wall of the base 1 or lid 4 so that the through hole and the two discharge pipes 5b are communicated with each other.

Further, it is preferred that the supply pipe 5a and the discharge pipe 5b have inner diameters of 0.1 mm or more so as to restrain pressure loss of a fluid and of 5 mm or less so as to be small in size and low in height.

The cross sections of the supply pipe 5a and the discharge pipe 5b may be circular normally, but not limited. In other words, they can be oval, and polygonal such that sides thereof can be aligned with a flowing direction of a fluid, for example, square and rectangular, other than circular. Moreover, the wall thickness thereof needs to be thick enough to avoid transformation by pressure due to supply of a raw material and discharge of reaction gas. In a case where the supply pipe and the discharge pipe are made of the metallic material such as an Fe—Ni alloy, an Fe—Ni—Co alloy and stainless steel, when used in mobile equipment or the like, a thickness of 0.1 mm or more is sufficient normally. Furthermore, the longer a length in the flowing direction is, the better it is for making it hard to conduct the heat generated in the fuel reformer 9 to a power generation cell, but the length should be a length considering the size of the whole fuel cell system.

Further, it is preferred that the supply pipe 5a and the discharge pipe 5b have a plurality of grooves parallel to an axial direction or a plurality of grooves perpendicular to the axial direction formed on the exterior side walls in regions inside the fuel reformer housing container 12. Consequently, it is possible to reduce the heat conduction of the supply pipe 5a and the discharge pipe 5b and to more effectively restrain the heat conduction from the fuel reformer 9 to the base 1 and lid 4, and to make the supply pipe 5a and the discharge pipe 5b transform moderately. As a result, it is possible to relieve stress by moderate transformation of the supply pipe 5a and the discharge pipe 5b, and it is possible to favorably maintain junction of the junctions of the supply pipe 5a and the discharge pipe 5b to the fuel reformer 9 and junction of the junctions of the supply pipe 5a and the discharge pipe 5b to the base 1 or the lid 4.

FIG. 2 is a cross sectional view showing a fuel reformer housing container and fuel reforming apparatus according to a second embodiment of the invention. The fuel reformer housing container and fuel reforming apparatus according to the embodiment are similarly structured to the fuel reformer housing container and fuel reforming apparatus according to the first embodiment of the invention. The corresponding component will be denoted by the same reference numeral and a description thereof will be omitted.

A fuel reforming apparatus includes a base 1, a lead terminal 2 serving as a wire, a bonding wire 3, a lid 4, a supply pipe 5a serving as a supplying passage for supplying fuel, a discharge pipe 5b serving as a discharging passage for discharging reformed gas, an electrode 7, an insulation sealing member 8 for sealing and fixing the lead terminal 2 in a through hole of the base 1 in an insulated state, and a fuel reformer 9. A fuel reformer housing container 12A for housing the fuel reformer 9 is mainly composed of the base 1, the lid 4, the supply pipe 5a and the discharge pipe 5b. Therefore, the fuel reforming apparatus comprises the fuel reformer housing container 12A and the fuel reformer 9.

In the embodiment, the lid 4 consists of a plurality of lid portions 4a and 4b (in the embodiment, 2) which are attached to the upper surface of the base 1 so as to be layered and have a gap therebetween, and lid portions 4a and 4b which are on more interior side are attached to more inner periphery of the upper surface of the base 1. Thereby, it is possible to effectively insulate the heat by the gap, i.e. the cavity S and largely reduce thermal conduction from the fuel reformer 9 to the most exterior side walls of the base 1 and lid 4. Therefore, it becomes possible to effectively restrain the temperature of an exterior side surface of the fuel reformer housing container 12A from rising. As a result, it is possible to effectively prevent other components in a mobile apparatus from being broken.

Further, the lid portions 4a and 4b which are on more interior side are attached to more inner periphery of the upper surface of the base 1. Therefore, even when a sealing trouble occurs at a junction between one lid portion 4a or 4b and the base 1, a junction between other lid portions 4b or 4a and the base 1 are maintained favorably. Consequently, airtightness inside the fuel reformer housing container 12A can be maintained, and it is possible to effectively restrain the heat in the fuel reformer 9 from being conducted to the most exterior side wall of the lid 4.

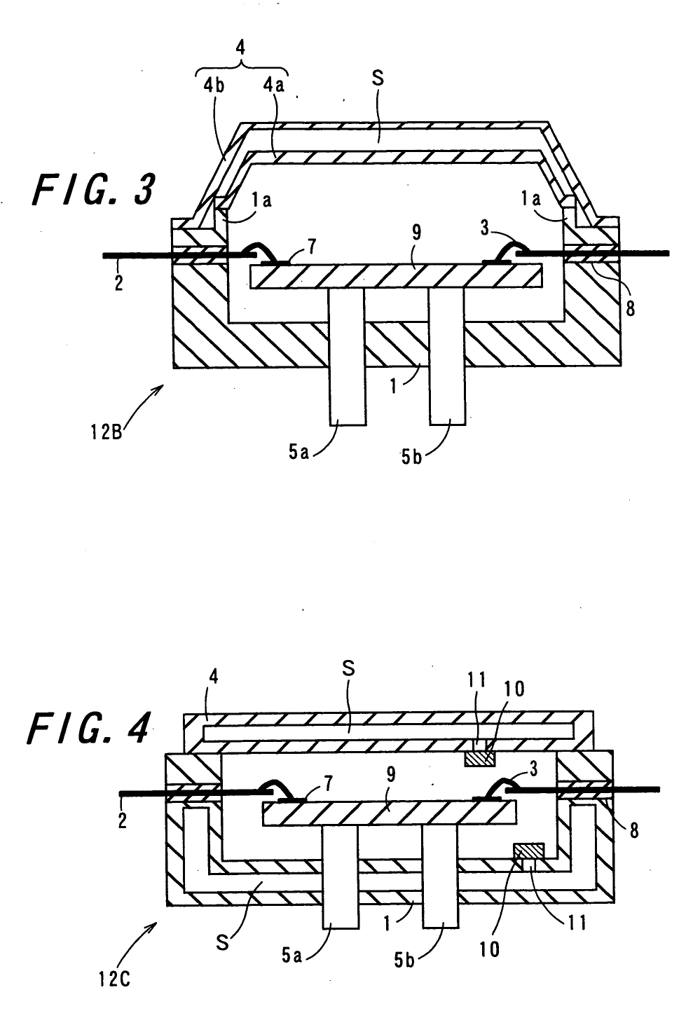

FIG. 3 is a cross sectional view showing a fuel reformer housing container and fuel reforming apparatus according to a third embodiment of the invention. The fuel reformer housing container and fuel reforming apparatus according to the embodiment are similarly structured to the fuel reformer housing container and fuel reforming apparatus according to the second embodiment of the invention. The corresponding component will be denoted by the same reference numeral and a description thereof will be omitted.

A fuel reformer housing container 12B according to the embodiment is mainly composed of the base 1, the lid 4, the supply pipe 5a and the discharge pipe 5b correspondingly to the fuel reformer housing container 12A according to the second embodiment of the invention. Therefore, the fuel reforming apparatus comprises the fuel reformer housing container 12B and the fuel reformer 9.

In the embodiment, as shown in the FIG. 3, an upper surface of the base 1 except the concave portion is shaped into a step 1a (in the embodiment, a higher surface of the step 1a is disposed closer to the concave portion than to the outside of the base 1), and the plurality of lid portions 4a, 4b are respectively attached to different surfaces of the step 1a. Therefore, in a case where the lid portions 4a, 4b are joined to the upper surface of the base via a brazing material, the adjacent lid portions 4a and 4b are connected by prevailing of the brazing material in a wet condition between the lid portions 4a and 4b, and an adhesion area of the brazing material with the upper surface of the base becomes larger so that stress is effectively restrained from arising on the adhesion surface. Further, in a case where the lid portions 4a, 4b are welded to the upper surface of the base 1, after welding one lid portion 4a, it is possible to make it difficult to conduct the heat to the junction of the lid portion 4a which is already welded, and the base 1 when another lid portion 4b is welded so that stress is effectively restrained from arising on the junction.

Thus, even when a space for joining on the upper surface of the base 1 becomes small by downsizing the fuel reformer housing container 12B, the plurality of lid portions 4a, 4b are joined to the base 1 with considerably high reliability.

Especially when the higher surface of the step 1a is disposed closer to the concave portion than to the outside of the base 1, it becomes easy to seam-weld the interior side lid portion 4a when the lid portion 4a, 4b are attached to the upper surface of the base by seam-welding. In other words, an electrode roller for seam-welding is disposed at an angle in order to increase a value of resistance on welding, however, the higher surface of the step 1a is disposed closer to the concave portion than to the outside of the base 1 and thereby, it can be effectively prevented that welding cannot be attained with the electrode roller in contact with the upper surface of the base 1 when the interior side lid portion 4a is welded.

Incidentally, in FIG. 3, the higher surface of the step 1a is disposed closer to the concave portion than to the outside of the base 1, but a lower surface of the step 1a may also be disposed closer to the concave portion to the outside of the base 1.

Further, in the second and third embodiments of the invention, it is preferable that the gap between the plurality of lid portions 4a and 4b has an inner pressure of 10 Pa or less. Therefore, since it is possible to lower molecular density in the air inside the gap, i.e. the cavity S, it is possible to effectively reduce the amount of heat conduction from the interior side surface of the most interior side lid portion 4a to the exterior side surface of the most exterior side lid portion 4b via the gap. As a result, it is possible to more effectively reduce the heat diffused outward from the fuel reformer 9 via the lid 4, and power generation loss can be reduced more by restraining the temperature of the fuel reformer 9 from decreasing, and the temperature of the fuel reformer housing container 12A, 12B can be more effectively restrained from rising.

Correspondingly, it is preferable that an inner pressure is 10 Pa or less in the fuel reformer housing container 12A, 12B, that is, a space between the most interior side lid portion 4a and the bottom surface of the concave portion of the base 1.

Thus, as a method for lowering the inner pressure between the plurality of lid portions 4a and 4b and between the most interior side lid portion 4a and the base 1, for example, when the lid portions 4a, 4b are joined, it is possible to implement by sealing by a brazing material inside a vacuum furnace, a seam weld method inside a vacuum chamber and the like. Alternatively, it may also be implemented by providing a through hole in the lid portions 4a, 4b, lowering pressure between the lid portions 4a, 4b and inside the concave portion of the base 1 by vacuuming up from the through hole, and thereafter by covering the through hole.

@2-045 Further, it is preferable that a distance of the gap between the plurality of lid portions 4a and 4b is from 0.5 mm to 5 mm. Thereby, a fuel reformer housing container 12A, 12B can be small in size and hardly conducts the heat outward and in which it is possible to favorably absorb a mechanical shock by the gap and reduce a shock directly conducting inward the fuel reformer housing container 12A, 12B to a large extent. As a result, it is possible to improve operating reliability of the fuel reformer 9 housed inside of the fuel reformer housing container 12A, 12B.

Further, it is preferable that a thickness of the lid portion 4 is 0.1 mm or more. Thereby, it is possible to more effectively reduce the heat diffused from the reformer 9 to the outside of the lid 4. As a result, it is possible to more effectively restrain the temperature of the fuel reformer 9 from decreasing and restrain the temperature of the fuel reformer housing container 12A, 12B from rising and thereby, power generation loss can be reduced more. Further, it is possible to increase the mechanical strength of the base 1 and lid 4, as a result, it can be favorably maintained to restrain the thermal conduction from the fuel reformer 9 to the most exterior side surfaces of the base 1 and lid 4, and it is possible to maintain efficiency of power generation as stable and high over a long period of time.

FIG. 4 is a cross sectional view showing a fuel reformer housing container and fuel reforming apparatus according to a fourth embodiment of the invention. The fuel reformer housing container and fuel reforming apparatus according to the embodiment are similarly structured to the fuel reformer housing container and fuel reforming apparatus according to the first embodiment of the invention. The corresponding component will be denoted by the same reference numeral and a description thereof will be omitted.

A fuel reforming apparatus includes a base 1, a lead terminal 2 serving as a wire, a bonding wire 3, a lid 4, a supply pipe 5a serving as a supplying passage for supplying fuel, a discharge pipe 5b serving as a discharging passage for discharging reformed gas, an electrode 7, an insulation sealing member 8 for sealing and fixing the lead terminal 2 in a through hole of the base 1 in an insulated state, a fuel reformer 9, and a gas suction port 10. A fuel reformer housing container 12C for housing the fuel reformer 9 is mainly composed of the base 1, the lid 4, the supply pipe 5a, the discharge pipe 5b, and the gas suction port 10. Therefore, the fuel reforming apparatus comprises the fuel reformer housing container 12C and the fuel reformer 9.

In the embodiment, similarly to the first embodiment of the invention, at least one of the base and the lid (in the embodiment, the base 1 and the lid 4) has a cavity S formed therein. Therefore, it is possible to effectively insulate the heat and largely reduce thermal conduction from the fuel reformer 9 to exterior side surfaces of the base 1 and lid 4. Therefore, it becomes possible to effectively restrain the temperature of an exterior side surface of the fuel reformer housing container 12C from rising. As a result, it is possible to effectively prevent other components in a mobile apparatus from being broken.

It is preferable that the cavity S has the inner pressure of 10 Pa or less in the base 1 and lid 4. Thereby, since it is possible to lower molecular density in the air inside the cavity S, the amount of heat conduction between an interior side wall and an exterior side wall of the base 1 via the cavity S can be effectively reduced. As a result, it is possible to more effectively reduce the heat conducted from the fuel reformer 9 to the base 1 and lid 4, and power generation loss can be reduced more by restraining the temperature of the fuel reformer from decreasing, and the temperature of the fuel reformer housing container 12C can be more effectively restrained from rising.

Correspondingly, it is preferable that an inner pressure is 10 Pa or less in the fuel reformer housing container 12C, that is, a space between the lid 4 and the bottom surface of the concave portion of the base 1.

Further, correspondingly to the first embodiment of the invention, it is preferable that the cavity S has a dimension of 0.5 mm to 5 mm in a direction perpendicular to interior side and exterior side walls of the base 1 and the lid 4. Thereby, a fuel reformer housing container 12C can be small in size and hardly conducts the heat outward, and it is possible to favorably absorb a mechanical shock by the cavity S and reduce a shock directly conducting inward the fuel reformer housing container 12C to a large extent. As a result, it is possible to improve operating reliability of the fuel reformer 9 housed inside of the fuel reformer housing container 12C. Further, in a case where insulation effectiveness is increased by lowering the pressure of the cavity S close to a vacuum, it is possible to restrain contact of the interior side and exterior side surfaces of the base 1 and lid 4 even with the base 1 and lid 4 deformed to some extent, and retain a stable structure. Therefore, it can be favorably maintained to restrain the thermal conduction from the fuel reformer 9 to the exterior side surface of the base 1 and lid 4.

Further, correspondingly to the first embodiment of the invention, it is preferable that the interior side walls and exterior sides wall of the base 1 and the lid 4 have thicknesses of 0.1 mm or more, respectively. Thereby, it is possible to more effectively reduce the heat diffused from the reformer 9 to the outside of the base 1 and lid 4. As a result, it is possible to more effectively restrain the temperature of the fuel reformer 9 from decreasing and restrain the temperature of the fuel reformer housing container 12C from rising and thereby, power generation loss can be reduced more. Further, since it is possible to increase the mechanical strength of the base 1 and lid 4, the cavity S in a stable volume can be retained. As a result, it can be favorably maintained to restrain the thermal conduction from the fuel reformer 9 to the most exterior side surfaces of the base 1 and lid 4, and it is possible to maintain efficiency of power generation as stable and high over a long period of time.

Correspondingly to the first embodiment of the invention, the cavity S of the base 1 may be formed on a part of the base 1, and it may also be formed so as to cover the entire surrounding of the concave portions. For example, it may be formed at the bottom or on the side so as to be parallel to the interior side and exterior side surfaces of the base 1, or it may be formed at the bottom or on the side of the base 1 in a row, parallel to the interior side and exterior side surfaces as though it has a dual structure.

In the embodiment, on a portion of the fuel reformer 9 side of the base 1 and lid 4, formed is a gas suction port 10 for decreasing pressure inside the cavity S. The gas suction port 10 can maintain airtightness inside the cavity S by being closed after vacuuming up gas inside the cavity S of the base 1 and lid 4 so that inner pressure reach a desired value.

The gas suction port 10 is a cylindrical member joined to an opening edge of a through hole 11 connected to a cavity S on a principal surface on the side of the fuel reformer 9 of the base 1 and lid 4 so as to communicate with the through hole 11, or joined by being built in the through hole 11. An end on the side of the fuel reformer 9 protrudes from the principal surface on the side of the fuel reformer 9 of the base 1 and lid 4. Such a gas suction port 10 is made of, for example, metal such as Cu and Al, and alloy such as an Fe—Ni alloy, an Fe—Ni—Co alloy and stainless steel. It is preferable to use soft material such as Cu and Al. In a case where the gas suction port 10 is made of the soft material such as Cu and Al, even when a stress occurs between the base 1 and lid 4 by a difference of expansion coefficient, the gas suction port 10 moderately deforms and thereby, it is possible to effectively prevent the base 1 and lid 4 from being damaged with a crack or the like.

A method for joining the gas suction port 10 to the base 1 and lid 4 includes, for example, a method in which, in a case where the base 1 and lid 4 are made of metal or alloy material, a pipe-shape gas suction port 10 of approximately 100 mm in length is joined to the opening edge of the through hole 11 on the principal surface on the side of the fuel reformer 9 of the base 1 and lid 4 by welding or brazing. In this case, the through hole 11 provided with the base 1 and lid 4 must be mounted so as to be on the side of the fuel reformer 9, that is, inside of the fuel reformer housing container 12C.

Next, the end of the gas suction port 10 is connected to a vacuum pump, and gas component inside the cavity S provided with the base 1 and lid 4 is discharged and thereby, desired inner pressure is attained by decreasing pressure inside the cavity S.

Then, after pressure value inside the cavity S reaches the desired value, a portion near the center of the gas suction port 10 (a portion protruding from the principal surface on the side o the fuel reformer 9 of the base 1 and lid 4) is welded with pressure and thereby, the cavity S and the outside are shut out. When needed, an unwanted part which protrudes ahead of a pressure-welded part of the gas suction port 10 may be cut off. Furthermore, it is also possible to enhance airtightness more by covering the cross-section with a brazing material and the like.

Incidentally, as a method for shutting the gas suction port 10, a brazing material and a resin adhesive may be used for sealing, as well as the above mentioned welding with pressure.

Further, it is preferable that an inner diameter of the gas suction port 10 is 0.1 mm or more. In a case where the inner diameter is shorter than 0.1 mm, time for decreasing pressure inside the cavity S is lengthen, and there is a danger that productivity is damaged.

Further, it is preferable that a portion which is shut out by welding with pressure of portions which protrude from the principal surface on the fuel reformer 9 side of the base 1 and lid 4 is minute over entire periphery. Thereby, it becomes easy to weld with pressure, and deformation of the gas suction port 10 by welding with pressure is smaller, and therefore it is possible to effectively prevent a strain stress by the deformation from being generated. Consequently, even when the gas suction port 10 has a high temperature by the heat by operation of the fuel reformer 9, it is possible to effectively prevent the pressure-welded part by the strain of the pressure-welded part from separating from.

Further, it is preferable that pressure inside of the fuel reformer housing container 12C is decreased to the same inner pressure inside the cavity. Thereby, even when the gas suction port 10 is broken and open, since the fuel reformer housing container 12C and the cavity S have the same inner pressure, airtightness of the fuel reformer housing container 12C and cavity S can be maintained, and it is possible to favorably maintain the restraint of thermal conduction from the fuel reformer 9 to an exterior side surface of the fuel reformer housing container 12C.

As a method for lowering the inner pressure between the lid 4 and the base 1, for example, when the lid is joined, it is possible to implement by sealing by a brazing material inside a vacuum furnace, a seam weld method inside a vacuum chamber and the like.

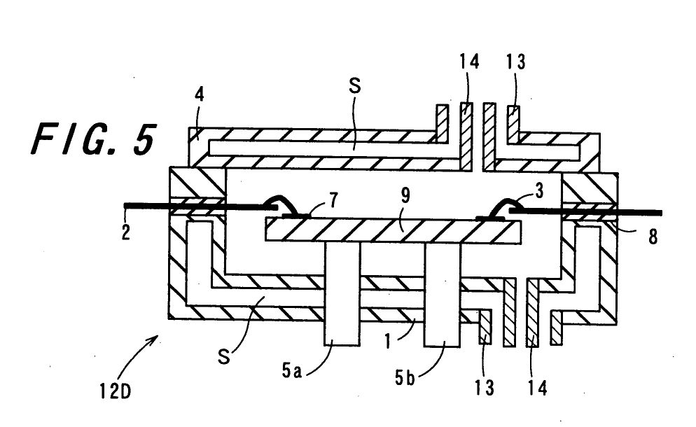

FIG. 5 is a cross sectional view showing a fuel reformer housing container and fuel reforming apparatus according to a fifth embodiment of the invention. The fuel reformer housing container and fuel reforming apparatus according to the embodiment are similarly structured to the fuel reformer housing container and fuel reforming apparatus according to the first embodiment of the invention. The corresponding component will be denoted by the same reference numeral and a description thereof will be omitted.

The fuel reforming apparatus includes a base 1, a lead terminal 2 serving as a wire, a bonding wire 3, a lid 4, a supply pipe 5a serving as a supplying passage for supplying fuel, a discharge pipe 5b serving as a discharging passage for discharging reformed gas, an electrode 7, an insulation sealing member 8 for sealing and fixing the lead terminal 2 in a through hole of the base 1 in an insulated state, a fuel reformer 9, a first gas suction pipe 13, and a second gas suction pipe 14. The fuel reformer housing container 12D for housing the fuel reformer 9 is mainly composed of the base 1, the lid 4, the supply pipe 5a, the discharge pipe 5b, a first gas suction pipe 13, and a second gas suction pipe 14. Therefore, the fuel reforming apparatus comprises the fuel reformer housing container 12D and the fuel reformer 9.

In the embodiment, correspondingly to the first embodiment of the invention, at least one of the base 1 and lid 4 (in the embodiment, base 1 and lid 4) has a cavity S formed therein. Thereby, it is possible to effectively insulate the heat, and since it is possible to largely reduce thermal conduction from the fuel reformer 9 to exterior side surfaces of the base 1 and lid 4, it becomes possible to effectively restrain the temperature of an exterior side surface of the fuel reformer housing container 12D from rising. As a result, it is possible to effectively prevent other components in a mobile apparatus from being broken.

In the base 1 and lid 4, it is preferable that the cavity S has the inner pressure of 10 Pa or less. Thereby, it is possible to lower molecular density in the air inside the cavity S, and effectively reduce the amount of heat conduction between the interior side surface and exterior side surface of the base 1 via the cavity S. As a result, it is possible to more effectively reduce the heat conducted from the fuel reformer 9 to the base 1 and lid 4, and power generation loss can be reduced more by restraining the temperature of the fuel reformer 9 from decreasing, and the temperature of the fuel reformer housing container 12D can be effectively restrained from rising.

Correspondingly, it is preferable that an inner pressure is 10 Pa or less in the fuel reformer housing container 12D, that is, a space between the lid 4 and the bottom surface of the concave portion of the base 1.

In the embodiment, in the fuel reformer housing container 12D, a first gas suction pipe 13 for decreasing pressure inside the cavity S is formed in the base 1 and lid 4. The first gas suction pipe 13 can maintain airtightness inside the cavity S by being closed after vacuuming up gas inside the cavity S of the base 1 and lid 4 so that inner pressure reach a desired value.

Further, in the fuel reformer housing container 12D, a second gas suction pipe 14 for decreasing pressure inside the fuel reformer housing container 12D is formed inside the first gas suction pipe 13. The second gas suction pipe 14 can maintain airtightness inside the space by being closed after inner pressure in the fuel reformer housing container 12D reach a desired value.

The first gas suction pipe 13 is a cylindrical member joined to an opening edge of a through hole connected to a cavity S of the base 1 and lid 4 so as to communicate with the through hole, or joined by being built in the through hole. Such a first gas suction pipe 13 is made of, for example, metal such as Cu and Al, and alloy such as an Fe—Ni alloy, an Fe—Ni—Co alloy and stainless steel. It is preferable to use soft material such as Cu and Al. In a case where the first gas suction pipe 13 is made of the soft material such as Cu and Al, even when a stress occurs between the base 1 or lid 4 and the first gas suction pipe 13 by a difference of expansion coefficient, the first gas suction pipe 13 moderately deforms and thereby, it is possible to effectively prevent the base 1 and lid 4 from being damaged with a crack or the like.

The second gas suction pipe 14 is a cylindrical member which is connected to the inside of the fuel reformer housing container 12D and formed inside the first gas suction pipe 13. Further, correspondingly to the first gas suction pipe 13, the gas suction pipe 14 is made of, for example, metal such as Cu and Al, and alloy such as an Fe—Ni alloy, an Fe—Ni—Co alloy and stainless steel. It is preferable to use soft material such as Cu and Al.

As a method for joining the first gas suction pipe 13 and the second gas suction pipe 14 to the base 1 and lid 4, for example, in a case where the base 1 and the lid 4 have a dual structure in which an inside member which is made of metal or alloy materials, and an outside member which is made of metal or alloy materials are joined so as to form the cavity S, they are produced as follows. Firstly, the second gas suction pipe 14 which is made of a pipe-shape member of approximately 100 mm in length is joined to an opening edge of a through hole of each inside member of the base 1 and lid 4 by welding or brazing. Next, the base 1 and the lid 4 are formed by joining each outside member of the base 1 and lid 4 to a periphery portion of the inside member. Thereafter, correspondingly to the second gas suction pipe 14, the first gas suction pipe 13 which is made of a pipe-shape member of approximately 100 mm in length is joined to a through hole of the outside member of the base 1 and lid 4.

It is preferable that the second gas suction pipe 14 protrudes outward than the opening of the first gas suction pipe 13. Thereby, it is possible to separately vacuum up the fist gas suction pipe 13 and the second gas suction pipe 14 respectively and vacuum up as maintaining a state where inner pressure of the cavity S of the base 1 and cavity S of the lid 4 is different from that of the fuel reformer housing container 12D. In other words, as vacuuming up under a state where the inner pressure of the cavity S of the base 1 and cavity S of the lid 4 is smaller than that of the fuel reformer housing container 12D, after the inner pressure of the cavity S of the base 1 and cavity S of the lid 4 is firstly brought to a desired value, the inner pressure of the fuel reformer housing container 12D is brought to a desired value. Thereby, a difference of air pressure becomes very wide, and it is possible to effectively restrain the base 1 and lid 4 from sagging, and the airtightness of the fuel reformer housing container 12D can become favorable.

As a method for decreasing pressure in the cavity S and fuel reformer housing container 12D, ends of the first gas suction pipe 13 and the second gas suction pipe 14 are connected to a vacuum pump, and gas component inside the cavity S provided with the base 1 and lid 4 and inside the fuel reformer housing container 12D is discharged and thereby, desired inner pressure is attained by decreasing pressure therein.

Then, after pressure value inside the fuel reformer housing container 12D reaches the desired value, a portion near the center of the first gas suciton pipe 13 (a portion protruding from the principal surface on the side of the fuel reformer 9 of the base 1 and lid 4) is welded with pressure and thereby, the second gas suction pipe 14 is simultaneously welded with pressure, and the cavity S and the fuel reformer housing container 12D, and the outside can be shut out. When needed, an unwanted part which protrudes ahead of a pressure-welded part of the first gas suction pipe 13 and the second gas suction pipe 14 may be cut off. Furthermore, it is also possible to enhance airtightness more by covering the cross-section with a brazing material.

Incidentally, as a method for shutting the first gas suction pipe 13 and the second gas suction pipe 14, a brazing material and a resin adhesive may be used for sealing, as well as the above mentioned welding with pressure.

Correspondingly to the first embodiment of the invention, the cavity S of the base 1 may be formed on a part of the base 1, and it may also be formed so as to cover the entire surrounding of the concave portions. For example, it may be formed at the bottom or on the side so as to be parallel to the interior side and exterior side surfaces of the base 1, or it may be formed at the bottom or on the side of the base 1 in a row, parallel to the interior side and exterior side surfaces as though it has a dual structure.

The above embodiment does not restrict the invention, and may be changed in various manners within the scope of the invention. For example, in the embodiment of the invention shown in FIGS. 1 to 5, the fuel pipe 5a and the discharge pipe 5b are joined to the under surface of the fuel reformer 9, but they may be joined to upper surface of the fuel reformer 9 according to specifications of the fuel reformer 9. Moreover, a plurality of supply pipes 5a and discharge pipes 5b may be formed.

The invention may be embodied in other specific forms without departing from the spirit or essential characteristics thereof. The present embodiments are therefore, to be considered in all respects as illustrative and not restrictive, the scope of the invention being indicated by the appended claims rather than by the foregoing description and all changes which come within the meaning and the range of equivalency of the claims are therefore, intended to be embraced therein.

1. A fuel reformer housing container comprising:
a base having one surface including a concave portion for housing a fuel reformer for generating reformed gas including hydrogen gas from fuel therein;
a lid attached to the one surface of the base so as to cover the concave portion;
a supply pipe for supplying fuel to the fuel reformer, the supply pipe piercing at least one of the base and the lid so that a front end thereof is joined to the fuel reformer, and holding the fuel reformer in a space between the lid and a bottom surface of the concave portion; and
a discharge pipe for discharging the reformed gas, the discharge pipe piercing at least one of the base and the lid so that a front end thereof is joined to the fuel reformer, and holding the fuel reformer in a space between the lid and the bottom surface of the concave portion,
wherein at least one of the base and the lid has a cavity formed therein.

2. The fuel reformer housing container of claim 1, wherein the cavity has a dimension of 0.5 mm to 5 mm in a direction perpendicular to walls on interior side and exterior side of the at least one of the base and lid which define the cavity.

3. The fuel reformer-housing container of claim 1, wherein the interior side wall and exterior side wall of the at least one of the base and the lid which define the cavity have thicknesses of 0.1 mm or more, respectively.

4. The fuel reformer housing container of claim 1, wherein the lid consists of a plurality of lid portions which are attached to the one surface of the base so as to be layered and have a gap therebetween, and lid portions which are on more interior side are attached to more inner periphery of the one surface of the base.

5. The fuel reformer housing container of claim 4, wherein the one surface of the base except the concave portion is shaped into a step, and the plurality of lid portions are respectively attached to different surfaces of the step.

6. The fuel reformer housing container of claim 4, wherein a distance of the gap is from 0.5 mm to 5 mm.

7. The fuel reformer housing container of claim 4, wherein thicknesses of the lid portions are 0.1 mm or more.

8. The fuel reformer housing container of claim 1, wherein the cavity formed in at least one of the base and the lid has a pressure reduced to lower than the atmosphere pressure, and the at least one of the base and the lid has a gas suction port for reducing pressure of the cavity provided in a portion on the fuel reformer side of the at least one of the base and the lid.

9. The fuel reformer housing container of claim 8, wherein the cavity has a dimension of 0.5 mm to 5 mm in a direction perpendicular to walls on interior side and exterior side of the at least one of the base and lid which define the cavity.

10. The fuel reformer housing container of claim 8, wherein the interior side wall and exterior side wall of the at least one of the base and lid which define the cavity have thicknesses of 0.1 mm or more, respectively.

11. The fuel reformer housing container of claim 1, wherein the cavity of the at least one of the base and the lid has a pressure reduced to lower than the atmosphere pressure, and a first gas suction pipe for reducing pressure of the cavity is formed in the exterior side wall of the at least one of the base and the lid and a second gas suction pipe for reducing pressure in the fuel reformed housing container is formed in the interior side wall of the at least one of the base and the lid so as to extrude from the interior side wall through an inside to an opening of the first gas suction pipe.

12. The fuel reformer housing container of claim 11, wherein the second gas suction pipe protrudes outwardly from the opening of the first gas suction pipe.

13. The fuel reformer housing container of claim 1, wherein the cavity has an inner pressure of 10 Pa or less.

14. A fuel reforming apparatus comprising:
the fuel reformer housing container of claim 1; and
a fuel reformer installed in the concave portion for generating reformed gas including hydrogen gas from fuel.

15. The fuel reforming apparatus of claim 14, wherein the concave portion has an inner pressure of 10 Pa or less.
